(19) United States
(12) Patent Application Publication
(10) Pub. No.: US 2018/0199121 A1
(43) Pub. Date: Jul. 12, 2018

(54) Collapsible Door Enclosure

(71) Applicant: Bose Corporation, Framingham, MA (US)

(72) Inventors: Matthew Mittleman, Macomb, MI (US); Scott Boulanger, Highland, MI (US)

(21) Appl. No.: 15/402,986

(22) Filed: Jan. 10, 2017

(51) Int. Cl. H04R 1/02; B60R 11/02

(52) U.S. Cl. CPC H04R 1/025; H04R 1/026; B60R 2011/0021; H04R 2499/13; B60R 11/0217

(57) ABSTRACT

In one aspect, this document features an enclosure for housing an acoustic transducer. The enclosure is configured to be disposed in a vehicle between an inner panel and an outer panel of the vehicle, the inner panel being closer to an interior of the vehicle than the outer panel. The enclosure includes a structure enclosing an acoustic volume for the acoustic transducer, the structure having multiple segments that include a first segment configured to be attached to the inner panel, and two or more subsequent segments disposed at increasing distances from the first segment towards the outer panel. Each of the multiple segments is connected to at least one other of the multiple segments by an interface that is configured to allow the corresponding segments to separate upon an impact, thereby allowing one or more of the multiple segments to collapse into corresponding adjacent segments.

### TECHNICAL FIELD

This disclosure generally relates to automotive speakers such as speakers mounted in a vehicle door.

### BACKGROUND

Vehicle audio systems can include speakers disposed in various portions of a body of a vehicle. In some cases, the speakers are disposed within a door of the vehicle.

### SUMMARY

In one aspect, this document features an enclosure for housing an acoustic transducer. The enclosure is configured to be disposed in a vehicle between an inner panel and an outer panel of the vehicle, the inner panel being closer to an interior of the vehicle than the outer panel. The enclosure includes a structure enclosing an acoustic volume for the acoustic transducer, the structure having multiple segments that include a first segment configured to be attached to the inner panel, and two or more subsequent segments disposed at increasing distances from the first segment towards the outer panel. Each of the multiple segments is connected to at least one other of the multiple segments by an interface that is configured to allow the corresponding segments to separate upon an impact, thereby allowing one or more of the multiple segments to collapse into corresponding adjacent segments.

In another aspect, this document features a speaker assembly configured to be disposed in a vehicle. The speaker assembly includes an acoustic transducer configured to deliver acoustic energy to an interior of the vehicle and a collapsible structure disposed between an inner panel and an outer panel of the vehicle, the inner panel being closer to the interior of the vehicle than the outer panel. The collapsible structure houses at least a portion of the acoustic transducer, and has multiple segments that include a first segment configured to be attached to the inner panel and two or more subsequent segments disposed at increasing distances from the first segment towards the outer panel. Each of the multiple segments is connected to at least one other of the multiple segments by an interface that is configured to allow the corresponding segments to separate upon an impact, thereby allowing one or more of the multiple segments to collapse into corresponding adjacent segments.

Implementations of the above aspects can include one or more of the following features.

The interface between the first segment and the adjacent subsequent segment can be disposed along a perimeter of the adjacent subsequent segment. The multiple segments can be configured to be compressible upon impact into a space of a predetermined width. The predetermined width can be between 0 and 150 mm. The structure can include three subsequent segments disposed at increasing distances from the first segment. A cross-section area of each of the subsequent segments can decrease with increasing distance from the first segment. The multiple segments can be configured to collapse into the corresponding adjacent segments without causing a detachment of the acoustic transducer from the enclosure. The multiple segments can be configured to collapse into the corresponding adjacent segments without causing a detachment of the acoustic transducer from the speaker assembly. A distance between two consecutive interfaces closest to the first segment can be less than a distance between the acoustic transducer and the interface between the first segment and the corresponding adjacent subsequent segment. The two or more subsequent segments can be configured to collapse into the first segment. The interface between two of the multiple segments can include a step.

Various implementations described herein may provide one or more of the following advantages. By providing a vehicular speaker enclosure that includes two or more telescopically collapsible segments, the speaker enclosure can be configured to collapse into a space of predetermined width in the event of a crash. In some cases, this may prevent the collapsed speaker enclosure from exerting significant force on the user-facing or cabin-facing portions of the speaker (e.g., speaker cover, speaker cone, etc.). This in turn may prevent such portions from being dislodged and propelled into the vehicle cabin in the event of a crash. Safety of body-mounted or door-mounted vehicular speakers may therefore be improved. The number of telescopic segments of the collapsible structure may be configured in accordance with a target acoustic volume for the speaker, such that acoustic performance of a body-mounted or door-mounted speaker is not significantly affected.

Two or more of the features described in this disclosure, including those described in this summary section, may be combined to form implementations not specifically described herein.

The details of one or more implementations are set forth in the accompanying drawings and the description below. Other features, objects, and advantages will be apparent from the description and drawings, and from the claims.

### DESCRIPTION OF THE DRAWINGS

FIG. 1 shows a partial side view of a vehicle and illustrates an example of a side-impact zone.

FIGS. 2A and 2B show front and perspective views, respectively, of an example door-mounted speaker assembly that includes a collapsible structure.

FIG. 3A shows a side view of an implementation of a speaker assembly, wherein the speaker enclosure is in an uncollapsed state.

FIG. 3B shows the speaker assembly of FIG. 2A in a collapsed state.

FIG. 4 shows an implementation of a speaker assembly mounted in a vehicle door including a speaker cover.

### DETAILED DESCRIPTION

In automotive audio systems, acoustic transducers or speakers are often disposed within vehicle doors (e.g., doors used in cars, trucks, buses, or other automobiles) or other portions of a vehicle body. Speakers can be integrated into a vehicle door at various locations. In some cases, speakers are integrated within a portion near the lower end of a door. In some cases, speakers are integrated within a relatively higher portion of the door, for example, to dispose the speaker proximate to the arms, chest, or head of an occupant of the seat adjacent to the door. In some cases, such door-mounted or body-mounted speakers can provide good acoustic performance (e.g., in terms of providing surround sound effects, inter-seat isolation etc.) by virtue of being close to the ears of the seat occupant.

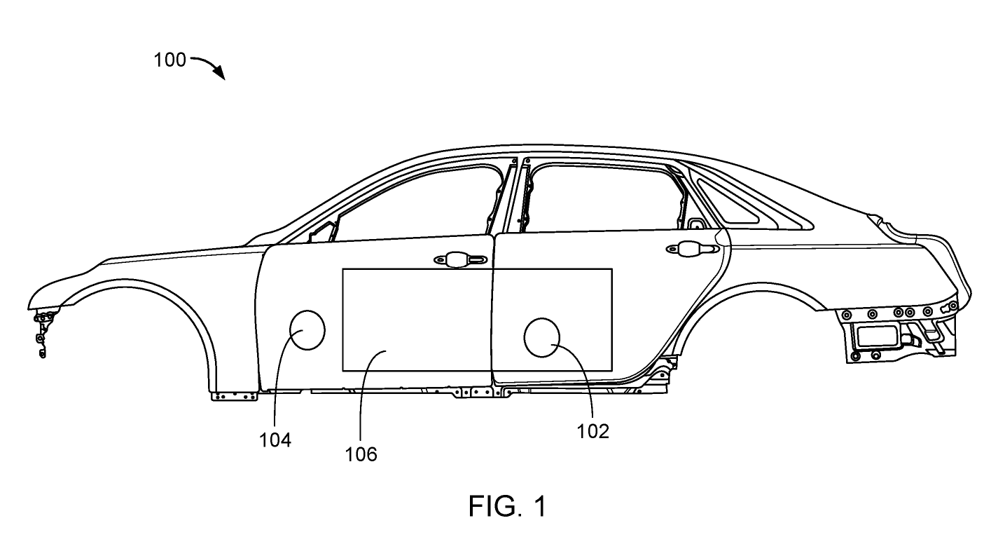

As shown in FIG. 1, door-mounted speakers 102 and 104 are often located in a side-impact zone 106 of a vehicle 100. Therefore, in the event of an accident or crash involving a side-impact, door mounted speakers 102 and 104 may be subjected to significant forces. In such cases, portions of the speaker assembly disposed within the door can be crushed inwards toward the interior or cabin of the vehicle. If such crushed portions come in contact with the cabin-facing components such as speaker cones or speaker grills, the force exerted on the cabin-facing components may be sufficient to dislodge and/or propel them into the cabin of the vehicle, thereby enhancing the risk of injury to any occupant.

The technology described in this document addresses the above concerns by providing a segmented speaker enclosure in which individual segments of the enclosure collapse into adjacent ones upon impact. Disposing such a speaker enclosure within a vehicle door may in some cases reduce the likelihood of a collapsed enclosure exerting significant forces on the cabin-facing speaker components (e.g., a speaker cone or a speaker cover), thereby potentially mitigating the risk of dislodging and/or propelling such components into the passenger cabin in the event of a crash or accident. By providing a speaker assembly that includes an enclosure with a segmented structure, the technology combines the integration advantages of door-mounted speakers while potentially improving the safety of such speakers in crash situations. In addition, the number of segments in the structure can be determined in accordance with a target acoustic volume such that the safety objectives may be attained without a significant loss in acoustic performance of the speakers. This document primarily uses examples of door-mounted speakers disposed in a lower portion of a vehicle door, near the feet of passengers in adjacent seats. However, the technology may be applicable to other types of door-mounted speakers, as well as speakers disposed in other portions of a vehicle body.

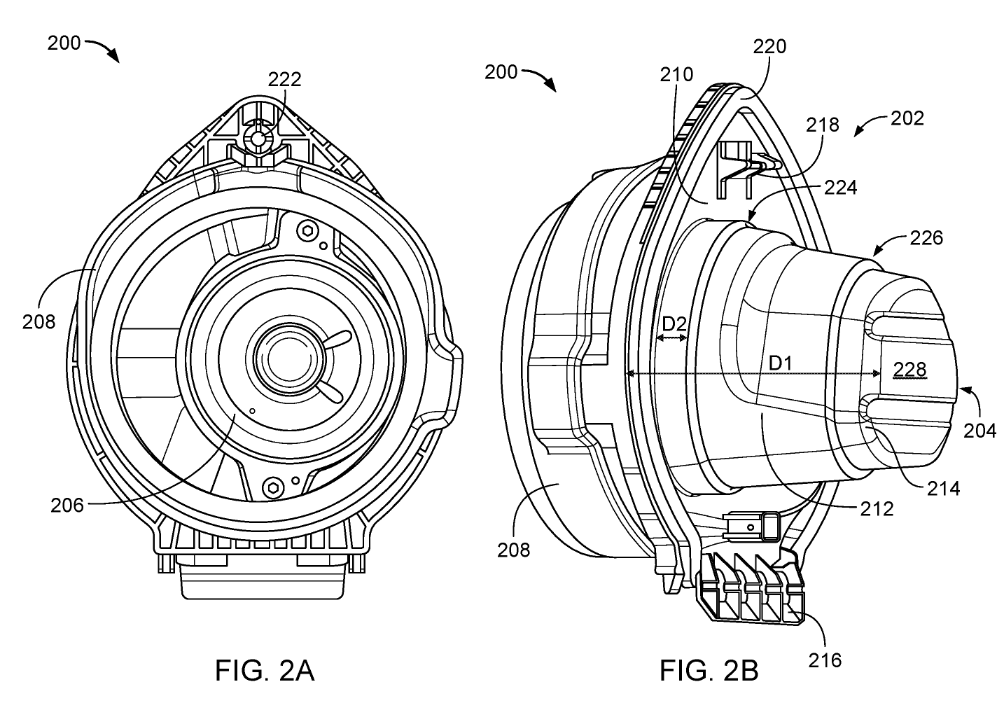

FIGS. 2A and 2B show front and perspective views, respectively, of a speaker assembly 200 including an enclosure 202 with a collapsible structure 204. The speaker assembly 200 includes an acoustic transducer 206 for delivering acoustic energy into the passenger cabin of a vehicle. In some implementations, the acoustic transducer 206 is attached to a supporting structure 208, which is also coupled to the enclosure 202.

The enclosure 202 can be disposed in a vehicle between an inner panel and an outer panel of the vehicle, the inner panel being closer to an interior of the vehicle than the outer panel. For example, the enclosure 202 may be disposed between an inner panel and an outer panel of a vehicle door. The enclosure 202 includes a collapsible structure 204 that includes multiple segments 210, 212, and 214. While FIG. 2B shows three segments, the structure 204 may have additional segments. The first segment 210, which is closer to the acoustic transducer 206 than the other segments, is configured to be attached to an inner panel of a vehicle door. In some implementations, the first segment 210 can include one or more of a hook 216 and a clip 218 for securing the enclosure 202 to the inner panel. In some implementations, a sealing element 220 is disposed at the interface of the enclosure 202 and the inner panel upon attachment of the enclosure 202 to the inner panel. The first segment 210 can also include a screw boss 222, through which a screw may be inserted to couple the enclosure 202 to the inner panel. The first segment has a depth D2 measured from the interface with the inner panel to an interface 224 with a proximal subsequent segment 212. In some implementations, D2 may be less than 25 mm. In some implementations, D2 may be approximately 18 mm. The depth of the individual segments 210, 212, and 214 can be configured such that in a collapsed state, each of the segments are accommodated into a space of predetermined dimensions (e.g., an expected separation between the inner panel and outer panel of a vehicle door or body in the event of a crash).

The collapsible structure 204 also includes at least two subsequent segments 212, 214, which, together with the first segment 210, enclose an acoustic volume for the acoustic transducer 206. In the following description, the segment nearest to the first segment 210 is referred to as a proximal subsequent segment 212, and the subsequent segment further away from the first segment 210 is referred to as a distal subsequent segment 214. In other implementations however, additional segments may be disposed in increasing distances from the first segment. In some implementations, the collapsible structure 204 may include more than three segments. For example, in some cases, there may be a middle subsequent segment disposed between the proximal subsequent segment 212 and the distal subsequent segment 214 and separated from each by an interface. In some implementations, a cross-section area of each of the subsequent segments decreases with increasing distance from the first segment.

The proximal subsequent segment 212 is connected to the first segment 210 at an interface 224. The interface 224 is configured to act as a breaking zone, such that in the event of an impact or crash, the proximal subsequent segment 212 separates from the first segment 210 along the interface 224, and collapses into the first segment 210. The distal subsequent segment 214 is connected to the proximal subsequent segment 212 at an interface 226. Similar to the interface 224, the interface 226 is configured to act as a breaking zone, such that in the event of an impact or crash, the distal subsequent segment 214 separates from the proximal subsequent segment 212 along the interface 226, and collapses into the 204 proximal subsequent segment 212. In some implementations, the two or more segments of the collapsible structure 204 can be connected by corresponding interfaces that give way upon impact allowing the segments to telescopically collapse into an adjoining segment. This in turn may allow the structure 204 to collapse into a region of predetermined width (e.g., an expected separation between the inner and outer door panels in the event of a crash) without exerting significant forces on cabin-facing components of the speaker assembly.

The collapsible structure 204 has a depth D1 measured from the inner panel (upon the speaker assembly being mounted between the inner and outer panels of a vehicle door or vehicle body) to a distal surface 228 of the distal subsequent segment 214. D1 may be within a range of 80 to 120 mm. In one implementation, D1 may be approximately 100 mm.

In some implementations, at least one of the interfaces 224 and 226 may include a step. For example, if the diameter of the first segment 210 is larger than the diameter of the proximal subsequent segment 212, the interface 224 may form a step. In other implementations, one or both of the interfaces 224 and 226 may include a material that is more likely to break (e.g. thinner, more brittle, etc.) than the material making up the first segment 210, the proximal subsequent segment 212, and the distal subsequent segment 214. In implementations, the interfaces can include thin, sharp corners, reduced radii, or perpendicular surfaces to act as stress points.

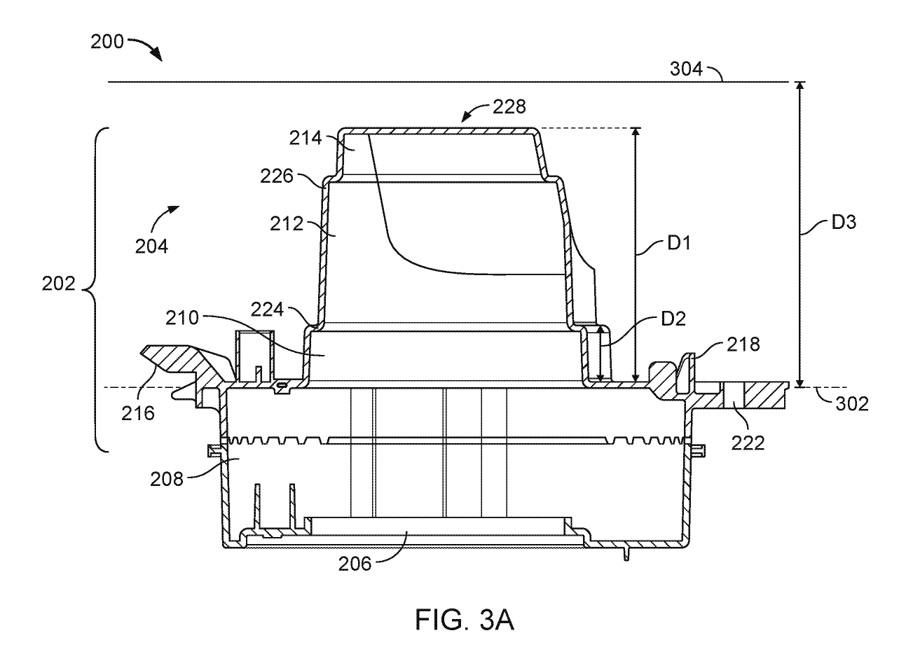

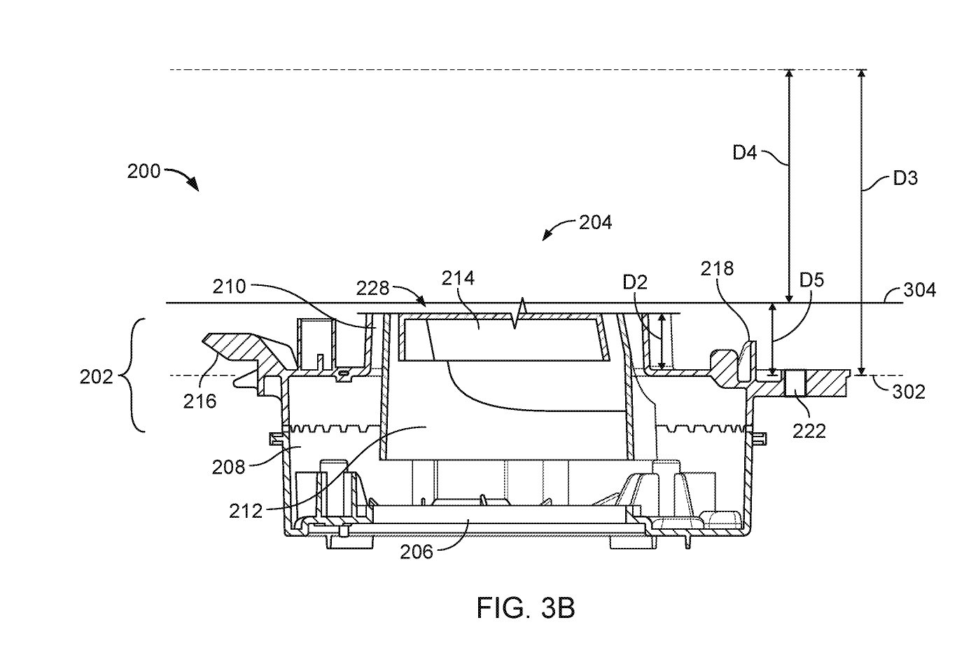

FIG. 3A shows a side view of the speaker assembly 200 including the collapsible structure 204. In this particular example, the speaker assembly 200 is attached to an inner panel 302 of the door using a hook 216 and a clip 218. In some implementations, other types of fasteners (e.g., screws or other attachment mechanisms) may be used for attaching the speaker assembly to the inner panel 302 either in conjunction with or instead of the hook and clip mechanism illustrated in FIG. 3A. Under normal operating conditions (e.g., when the vehicle door or body has not been impacted by a crash), the inner door panel 302 is separated from an outer door panel 304 by a distance of D3. In some implementations, D3 may be in the range of 120-150 mm. In the event of a crash, impact forces on the panels may cause the inner and outer panels to move towards each other. The expected separation between the two panels in the event of a crash may be empirically determined, for example, via crash tests or other experiments.

FIG. 3B shows a side view of the speaker assembly of FIG. 3A in a collapsed state. In this example, the collapsible structure 204 mounted between an inner panel and outer panel of a vehicle door is shown to have moved towards each other due to an impact such as one that can occur due to a crash. In this example, the outer door panel 304 is pushed toward the inner door panel 302 by the impact by a distance D4, and comes to rest at a distance D5 from the inner door panel. The distance D5 may be substantially equal to the expected separation between the two panels in the event of a crash. For example, D5 may be between 5 and 30 mm. Referring back to FIG. 3A, the depth of the individual segments, including the depth of the first segment D2, can be configured to be less than or equal to distance D5 such that the segments, in a collapsed state are accommodated within the separation D5.

During traversing the distance D4, the outer door panel makes contact with the distal surface 228 of the distal subsequent segment 214. Upon application of a sufficient force to the distal surface 228, the distal subsequent segment 214 separates from the proximal subsequent segment 212 along interface 226. In some implementations, a force sufficient to cause such separation may be larger or substantially equal to 200 lbs. In some implementations, the interface 226 may form a perimeter between the distal subsequent segment 214 and the proximal subsequent segment 212. Upon breaking at the interface 226, the distal subsequent segment 214 collapses inside the proximal subsequent segment 212. The impact force may also cause the collapsible structure 204 to break at the interface 224 between the proximal subsequent segment 212 and the first segment 210. Upon breaking at the interface 224, the proximal subsequent segment 212 collapses inside the first segment 210. After the proximal subsequent segment 212 has collapsed inside the first segment 210 and the distal subsequent segment 214 has collapsed inside the proximal subsequent segment 212 (e.g. in a telescoping fashion), the enclosure 202, in the collapsed form, is contained within the depth D2, i.e., in the separation between the inner and outer panels of the vehicle door. In some implementations, this may prevent the collapsed segments from exerting significant force on cabin-facing components of the speaker assembly 200, thereby preventing such components from being dislodged and/or propelled into the vehicle cabin in the event of a crash or impact.

In being confined to a depth of no more than D2, the structure 204, in the collapsed state, may be prevented from exerting a significant force on the cabin-facing components of the speaker assembly 200. In some cases, this may result in the speaker assembly 200 remaining attached to the door or the portion of the vehicle body in which it is disposed even after an impact to the door from the outside. For example, the shape and size of the proximal subsequent segment 212 and the distal subsequent segment 214 (and any additional segments that the collapsible structure 204 may have) may be configured such that upon collapsing into the first segment 210, the segments do not significantly interact (e.g. by dislodging, contacting, etc.) with the cabin-facing components (e.g., the acoustic transducer 206, a speaker grill or cover, etc.). In some implementations, the force of the impact on the outer panel 304 of the door may be absorbed, at least in part, by the motion of the outer panel 304 of the door through the distance D4, and by the breaking of the collapsible structure 204 at interfaces 224 and 226. As such, as a result of the collapsible structure 204 being divided into two or more collapsible segments, the speaker assembly 200 may remain contained within the reduced separation D5 between the inner panel 302 and the outer panel 304 in the event of a crash. In some cases, this may prevent the collapsed structure from exerting a force sufficient to dislodge or separate a cabin-facing component from the speaker assembly 200, and prevent such components from being propelled into the interior of the vehicle in the event of a crash.

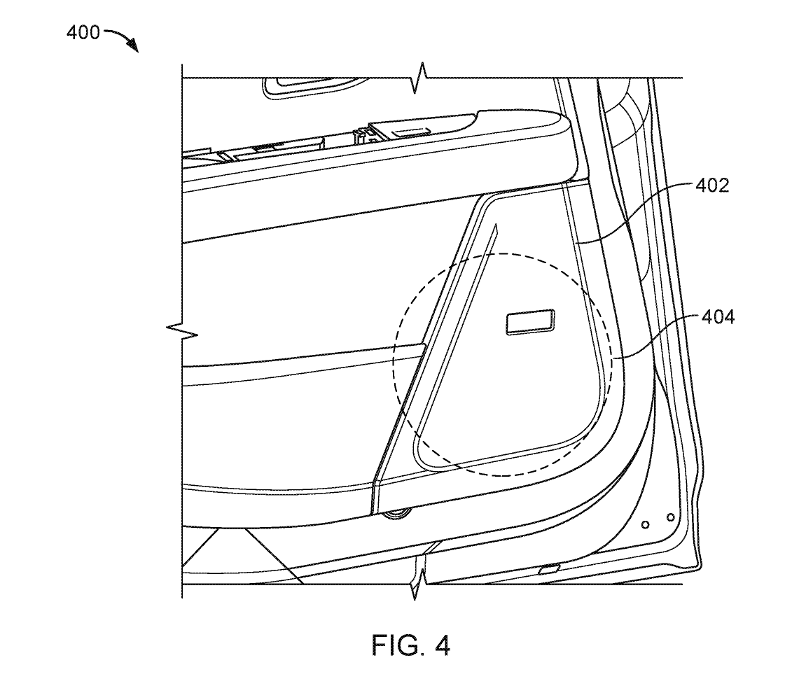

FIG. 4 shows a view of a rear vehicle door 400 from the interior of the vehicle, the door including a cover 402 for a speaker assembly. The speaker assembly 404 (which may be similar to the implementations shown in FIG. 2A or 3A) is mounted on an inner panel of the door 400 and covered with the cover 402. A collapsible structure (which may be similar to the collapsible structures 204 and 504 as discussed in relation to FIGS. 2A-2B and 3A-3B) may allow the speaker assembly to absorb enough force to prevent the cover 402 or an underlying acoustic transducer from being dislodged or propelled into the passenger cabin of the vehicle in the event of a crash.

Elements of different implementations described herein may be combined to form other embodiments not specifically set forth above. Elements may be left out of the structures described herein without adversely affecting their operation. Furthermore, various separate elements may be combined into one or more individual elements to perform the functions described herein.

1. An enclosure for housing an acoustic transducer, the enclosure configured to be disposed in a vehicle between an inner panel and an outer panel of the vehicle, the inner panel being closer to an interior of the vehicle than the outer panel, the enclosure comprising:
a structure enclosing an acoustic volume for the acoustic transducer, substantially all of the acoustic volume being located substantially coaxially behind the acoustic transducer, the structure having multiple segments that include:
a first segment configured to be attached to the inner panel, and
two or more subsequent segments disposed at increasing distances from the first segment towards the outer panel,
wherein each of the multiple segments is connected to at least one other of the multiple segments by an interface that is configured to allow the corresponding segments to separate upon an impact, thereby allowing one or more of the multiple segments to collapse into corresponding adjacent segments without causing a detachment of the acoustic transducer from the enclosure, and
wherein a number of segments is determined based on a target acoustic volume for the acoustic transducer.

2. The enclosure of claim 1, wherein the interface between the first segment and the adjacent subsequent segment is disposed along a perimeter of the adjacent subsequent segment.

3. The enclosure of claim 1, wherein the multiple segments are configured to be compressible upon impact into a space of a predetermined width.

4. The enclosure of claim 3, wherein the predetermined width is between 0 and 150 mm.

5. The enclosure of claim 1, wherein the structure includes three subsequent segments disposed at increasing distances from the first segment.

6. The enclosure of claim 1, wherein a cross-section area of each of the subsequent segments decreases with increasing distance from the first segment.

7. (canceled)

8. The enclosure of claim 1, wherein a distance between two consecutive interfaces closest to the first segment is less than a distance between the acoustic transducer and the interface between the first segment and the corresponding adjacent subsequent segment.

9. The enclosure of claim 1, wherein the two or more subsequent segments are configured to collapse into the first segment.

10. The enclosure of claim 1, wherein the interface between two of the multiple segments comprises a step.

11. A speaker assembly configured to be disposed in a vehicle, the speaker assembly comprising:
an acoustic transducer configured to deliver acoustic energy to an interior of the vehicle; and
a collapsible structure disposed between an inner panel and an outer panel of the vehicle, the inner panel being closer to the interior of the vehicle than the outer panel, the collapsible structure housing at least a portion of the acoustic transducer and enclosing an acoustic volume substantially all of which is located substantially coaxially behind the acoustic transducer, the collapsible structure having multiple segments that include:
a first segment configured to be attached to the inner panel, and
two or more subsequent segments disposed at increasing distances from the first segment towards the outer panel,
wherein each of the multiple segments is connected to at least one other of the multiple segments by an interface that is configured to allow the corresponding segments to separate upon an impact, thereby allowing one or more of the multiple segments to collapse into corresponding adjacent segments without causing a detachment of the acoustic transducer from the enclosure, and
wherein a number of segments is determined based on a target acoustic volume for the acoustic transducer.

12. The speaker assembly of claim 11, wherein the interface between the first segment and the adjacent subsequent segment is disposed along a perimeter of the adjacent subsequent segment.

13. The speaker assembly of claim 11, wherein the multiple segments are configured to be compressible upon impact into a space of a predetermined width.

14. The speaker assembly of claim 13, wherein the predetermined width is between 0 and 150 mm.

15. The speaker assembly of claim 11, wherein the structure includes three subsequent segments disposed at increasing distances from the first segment.

16. The speaker assembly of claim 11, wherein a cross-section area of each of the subsequent segments decreases with increasing distance from the first segment.

17. (canceled)

18. The speaker assembly of claim 11, wherein a distance between two consecutive interfaces closest to the first segment is less than a distance between the acoustic transducer and the interface between the first segment and the corresponding adjacent subsequent segment.

19. The speaker assembly of claim 11, wherein the two or more subsequent segments are configured to collapse into the first segment.

20. The speaker assembly of claim 11, wherein the interface between two of the multiple segments comprises a step.
